(19) United States
(12) Patent Application Publication
(10) Pub. No.: US 2023/0076722 A1
(43) Pub. Date: Mar. 9, 2023

(54) THREE-DIMENSIONAL PRINTING SYSTEM WITH HIGH CAPACITY SERVICING MODULE

(71) Applicant: Culinary Printworks, Inc., Ojai, CA (US)

(72) Inventors: Jacob C. Reid, Hubbard, OR (US); Ernest I. Esplin, Sheridan, OR (US)

(21) Appl. No.: 17/985,739

(22) Filed: Nov. 11, 2022

Related U.S. Application Data
(63) Continuation of application No. 16/920,049, filed on Jul. 2, 2020, now abandoned.
(60) Provisional application No. 62/869,790, filed on Jul. 2, 2019.

(51) Int. Cl. B29C 64/35; B29C 64/112; B29C 64/209; B29C 64/236; B29C 64/393; B33Y 50/02; B33Y 40/00; B33Y 30/00

(52) U.S. Cl. CPC B29C 64/35; B29C 64/112; B29C 64/209; B29C 64/236; B29C 64/393; B33Y 50/02; B33Y 40/00; B33Y 30/00

(57) ABSTRACT

A three dimensional printer includes a printhead, a movement mechanism coupled to the printhead, a maintenance module, and a controller. The printhead includes an ejection face with a plurality of nozzles for ejecting droplets of printing fluid. The maintenance module includes a maintenance tray and an effluent tray. The maintenance tray has a lateral periphery and an upper side including a storage cap, a wiper, and a spittoon. The effluent tray has a lateral periphery, underlies the maintenance tray, and receives accumulated fluid from the maintenance tray. The periphery of the maintenance tray and the periphery of the effluent tray interengage when the maintenance tray is removably mounted over the effluent tray. The controller is configured to operate the printhead, the maintenance module, and the movement mechanism to provide printing and printhead maintenance.

### CROSS-REFERENCE TO RELATED APPLICATIONS

The present application claims priority under 35 U.S.C. § 120 to U.S. patent application Ser. No. 16/920,049, which was filed on Jul. 2, 2020, and which claims priority to U.S. Provisional Application Ser. No. 62/869,790, which was filed on Jul. 2, 2019. The complete disclosures of these applications are hereby incorporated by reference.

### FIELD OF THE INVENTION

The present disclosure relates to a layer-by-layer fabrication of a three-dimensional article by a process that includes a use of a printhead. More particularly, the present disclosure concerns an improved maintenance module for the printhead.

### BACKGROUND

Three-dimensional printing systems are in wide use for fabricating three-dimensional articles with metals, plastics, ceramics, composites, and other materials. One major type of three-dimensional printing technology utilizes a dry powder and a liquid binding agent. The basic process is a repeated layer-by-layer dispensing of a uniform powder layer followed by a selectively dispensed binding agent. The selective dispensing of the binding agent determines a cross-section of the article for a given layer.

The binding agent that is used typically provides a matrix that binds together the particles. In some systems, the binding agent can react with or partially dissolve the particles. Some of these binding agents ere challenging to dispense with enough precision and reliably, For some systems, a “drop-on-demand” printhead such as a piezoelectric printhead is utilized to dispense the binding agents. Maintaining a piezoelectric printhead for dispensing binding agents is particularly challenging.

### BRIEF DESCRIPTION OF THE FIGURES

FIG. 1 is a block diagram schematic of a three-dimensional printing system.

FIG. 2 is an isometric drawing of a portion of an embodiment of a three-dimensional printing system.

FIG. 3 is an isometric view of an embodiment of a maintenance module in isolation.

FIG. 4 is a top view of an embodiment of a maintenance module in isolation.

FIG. 5 is a cutaway isometric view of an embodiment of an maintenance module.

FIG. 5A depicts cross-sectional detail of a portion of the maintenance module of FIG. 5 with particular emphasis on interengagement of peripheral portions of components and on a sensing system that includes a magnet and hall effect sensor.

FIG. 5B depicts cross-sectional detail of a portion of the maintenance module of FIG. 5 with emphasis on a seal between a motorized shaft and an effluent tray. The motorized shaft is used to raise and lower a maintenance tray.

FIG. 6A is a isometric drawing of a portion of an embodiment of a three-dimensional printing system with emphasis on a printhead purging operation. A vertical space is defined by a distance between an ejection face and an upper surface of a purge platform. During purging, the space becomes partially or completely filled with a mixture of printing fluids.

FIG. 6B is an isometric drawing of a portion of an embodiment of a three-dimensional printing system with emphasis on printhead wiping.

FIG. 7 is a flowchart depicting an embodiment of a method for manufacturing a three-dimensional article with emphasis on maintenance processes.

FIG. 8 is a flowchart depicting an embodiment of a method for manufacturing a three-dimensional article with emphasis on a maintenance process.

### SUMMARY

In a first aspect of the disclosure, a three dimensional printer includes a printhead, a movement mechanism coupled to the printhead, a maintenance module, and a controller. The printhead includes an ejection face with a plurality of nozzles for ejecting droplets of printing fluid. The maintenance module includes a maintenance tray and an effluent tray. The maintenance tray has a lateral periphery and an upper side including a storage cap, a wiper, and a spittoon. The effluent tray has a lateral periphery, underlies the maintenance tray, and receives accumulated fluid from the maintenance tray. The periphery of the maintenance tray and the periphery of the effluent tray interengage when the maintenance tray is removably mounted over the effluent tray. The controller is configured to: operate the printhead and the maintenance module to prepare the printhead for printing; operate the movement mechanism and the printhead to dispense layers of fluid; operate the movement mechanism and the maintenance module to engage the cap against the ejection face after printing. The movement mechanism can be configured to laterally translate the printhead along two lateral axes. The maintenance module can be configured to translate the maintenance tray along a vertical axis. The maintenance tray can also include a purge platform having an upper surface for receiving printing fluid during a printhead purge operation.

In one implementation, the periphery of the maintenance tray includes a downwardly facing peripheral recess. The periphery of the effluent tray includes an upwardly extending peripheral ridge. The peripheral ridge being received by the peripheral recess defines the interengagement when the maintenance tray is loaded over the effluent tray.

In another implementation, the interengagement defines a cavity between a lower side of the maintenance tray and an upper side of the effluent tray. The interengagement can form a complete perimeter around the cavity and to effectively seal the cavity.

In yet other implementation, the effluent tray includes a downwardly extending conduit that is coupled to a waste receptacle. The maintenance tray can include a downwardly extending fluid outlet that extends from the upper surface of the maintenance tray to within a cavity defined between a lower side of the maintenance tray and an upper side of the effluent tray. The fluid outlet can be positioned laterally over the conduit. The upper side of the effluent tray can slope downwardly toward the conduit.

In a further implementation, the maintenance tray includes a lower surface defining a recess. A magnet is contained within the recess. The effluent tray has a lower surface. A hall sensor mounted to the lower surface of the effluent tray. The controller is configured to determine whether the maintenance tray is mounted over the effluent tray based upon a signal from the hall sensor.

In a yet further implementation, an opening passes from a lower side to an upper side of the effluent tray. The maintenance module also includes a motorized vertical shaft passing through the opening and coupled to a lower side of the maintenance tray. The motorized vertical shaft is configured to raise and lower the maintenance tray to vary a relative vertical position of the maintenance tray with respect to the printhead. A seal is mounted within the opening and in sliding and sealing engagement with the vertical shaft. The vertical shaft includes a motor. The controller is configured to operate the motor to control the vertical height of the maintenance tray.

### DETAILED DESCRIPTION OF THE PREFERRED EMBODIMENTS

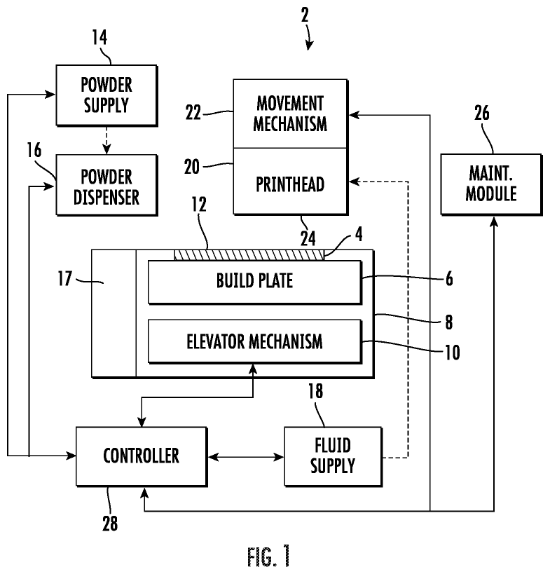

FIG. 1 is a block diagram schematic of a three-dimensional printing system 2 for printing a three-dimensional article 4. A build plate 6 is for supporting the three-dimensional article 4 within a build volume container 8. An elevator mechanism 10 is configured to controllably adjust a vertical position of the build plate 6 and also an upper surface 12 of either the build plate 6 or article 4 for dispensing and forming layers onto the article 4.

A supply of powder 14 is configured to provide the powder to a powder dispenser 16. The powder dispenser 16 is configured to controllably dispense layers of the powder onto the upper surface 12. The build volume container 8 includes an overflow chamber 17 for receiving excess powder during a powder dispensing operation.

A fluid supply 18 is configured to supply a printing fluid (e.g., a binding agent) to a printhead 20. The printhead 20 is a drop-on-demand fluid-jetting printhead 20. In an illustrative embodiment, the fluid jetting printhead 20 is a piezoelectric printhead with a plurality of drop ejectors or nozzles. A movement mechanism 22 is configured to impart a lateral motion along two axes between the printhead 20 and the build upper surface 12.

In an illustrative embodiment, the printhead includes an ejection face 24 having a plurality of nozzles. The fluid supply 18 provides a plurality of different printing fluids that are ejected by different nozzles. The printing fluids differ from one another in terms of chemical composition. They may be different from one another in terms of one or more of the chemistry and/or concentration of chemical components. In the illustrative embodiment, they differ in terms of colorant. In an illustrative embodiment, there are four different printing fluids with four different colorants including black, cyan, yellow, and magenta. In other embodiments, there can be more or less different colorants which can also include one or more of red, orange, green, blue, violet, white, and other primary colors. Also, the different printing fluids can vary in terms of colorant concentration such as full concentration cyan versus light cyan and magenta versus light magenta. In yet other embodiments, the colorants can include spot colors which have precisely controlled color coordinates for identity purposes. One use of spot colors is product branding which typically require exact color matches required by the trade dress of products.

A maintenance module 26 is for maintaining the printhead 20. An embodiment of maintenance module 26 will be discussed in more detail infra.

A controller is 28 is electrically or wirelessly coupled to various portions of the system 2 including the elevator mechanism 10, the powder supply 14, the powder dispenser 16, the fluid supply 18, the printhead 20, the movement mechanism 22, the maintenance module 26 and other portions of system 2. The controller includes a processor coupled to an information storage device. The information storage device includes a non-transient or non-volatile computer-readable storage medium storing software instructions or computer-readable code portions. When executed, the software instructions control the portions of the system 2 listed supra. The controller 28 can be a single computer integrated into system 2 or it can include more than one coupled computer including a host computer.

The controller 28 is configured to operate portions of the printing system 2 to manufacture the three-dimensional article 4 and to perform maintenance on the printhead 20. In an illustrative embodiment, printing-based manufacture includes the following steps: (1) operate the elevator mechanism 10 to vertically position the upper surface 12 for receiving a layer of powder; (2) operate the powder dispenser 16 to dispense a layer of powder onto the surface 12; (3A) operate the movement mechanism 22 to scan the printhead 20 over the powder layer and (3B) while scanning the printhead, operate the printhead 20 to selectively dispense printing fluids (binding agent) upon the dispensed powder lager; (4) repeat steps (1)-(3) to complete fabrication of the three-dimensional article 4.

Before, during, or after printing, the controller 28 can also control the fluid supply 18, the printhead 20, the movement mechanism 22, and the maintenance module 26 to maintain reliability of the printhead 20. The controller 28 can also operate these components to maintain the printhead 20 during idle (non-printing) periods of time.

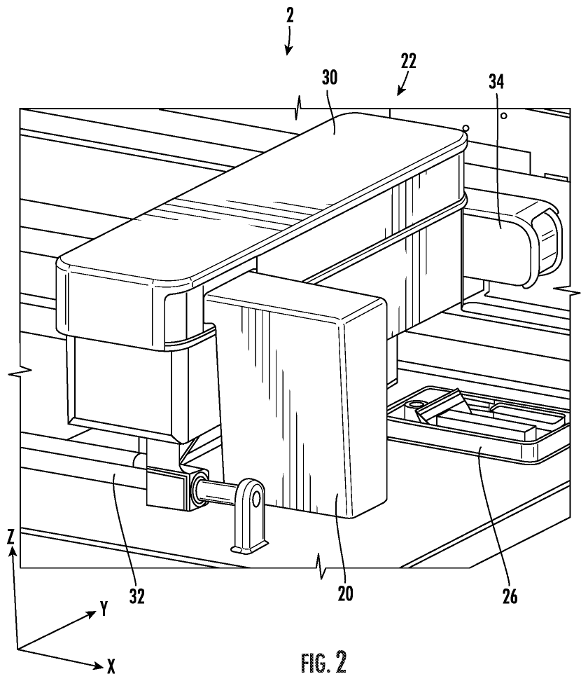

FIG. 2 is anisometric drawing of a portion of the three-dimensional printing system 2. In describing system 2, mutually perpendicular axes X, Y, and Z will be used. Axes X and Y are lateral axes that are generally horizontal. Axis Z is generally vertical By “generally” it is by design and to within manufacturing tolerances.

In the figure, printhead 20 is moved along X and Y by the movement mechanism 22. Movement mechanism 22 includes a main carriage 30 which is moved along a slider rod 32 by a belt mechanism 34. The slider rod 32 extends along the lateral X-axis. The printhead 20 is coupled to the main carriage 30 and configured to move along the carriage 30 along the Y-axis. The motion of printhead 20 with the carriage along X and along the carriage along Y allows the printhead access to powder layers for printing and to the maintenance module 26.

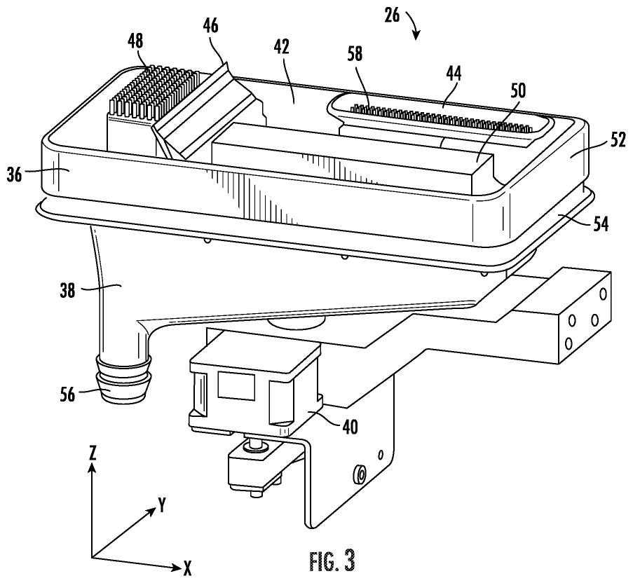

FIG. 3 is an isometric view of the maintenance module 26 in isolation. Maintenance module 26 includes a maintenance tray 36, effluent tray 38, and motor 40. The maintenance tray 36 is removably mounted over the effluent tray 38. “Removably mounted” in this context implies that a user of system 2 can remove the maintenance tray 36 for replacement or cleaning by grasping the maintenance tray 36 and pulling it straight up and off of the effluent tray 38. The motor 40 is configured to raise and lower the maintenance tray 36 along the vertical Z-axis.

The maintenance tray 36 has an upper side 42 that includes a storage cap 44, a wiper blade 46, a first spittoon 48, and a purge platform 50. A lateral extent of the maintenance tray 36 is bounded by a periphery 52. The lateral extent of the effluent tray 38 is bounded by a periphery 54. The effluent tray 38 has a downwardly extending conduit 56 for draining of accumulated fluid.

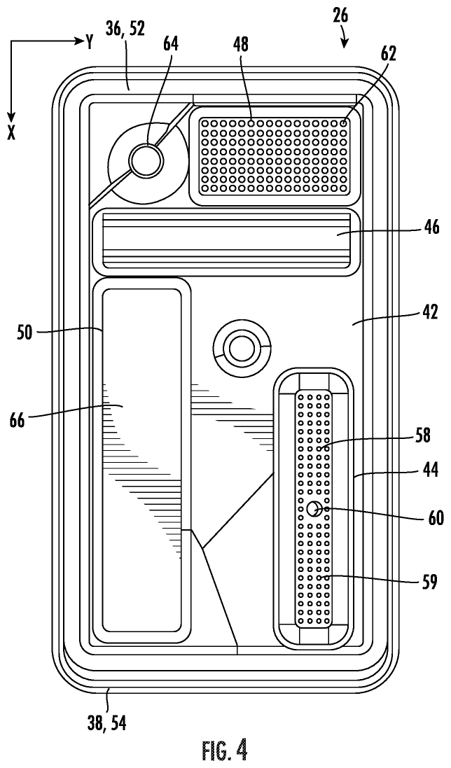

FIG. 4 is a top view of the maintenance module 26 that illustrates some additional details. The storage cap 44 includes an array of pillars 58 for absorbing ink droplets and a central opening 60. The array of pillars 58 allow the cap 44 to be utilized as a second spittoon 59. The central opening 60 relieves a pressure generated when the cap 44 sealingly engages the ejection face 24 of printhead 20 for storage. Unless otherwise specified, reference to a “spittoon” can refer to either the first spittoon 48 or second spittoon 59.

The first spittoon 48 includes an array of pillars 62 for absorbing printing fluid drops. Within or proximate to the first spittoon 48 is a fluid outlet 64 to allow printing fluid accumulating in the first spittoon 48 to drain to the effluent tray 38 and out the downwardly extending conduit 56. The purge platform 50 has a generally domed (convex upward) and nonporous upper surface 66. In some embodiments, the upper surface 66 is flat or with some other geometry.

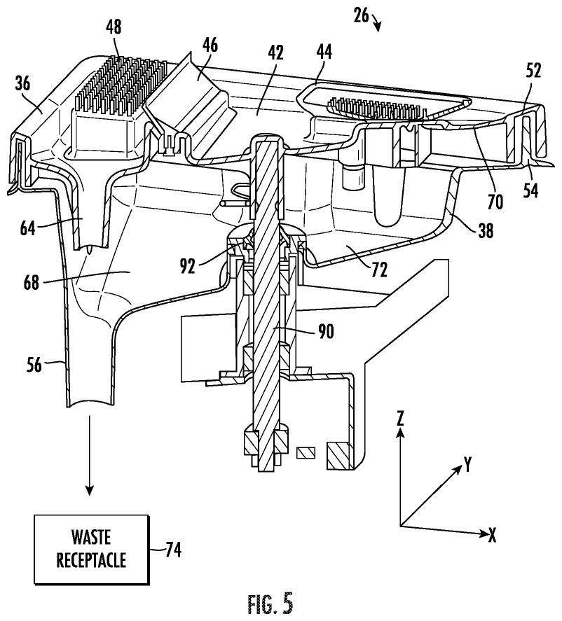

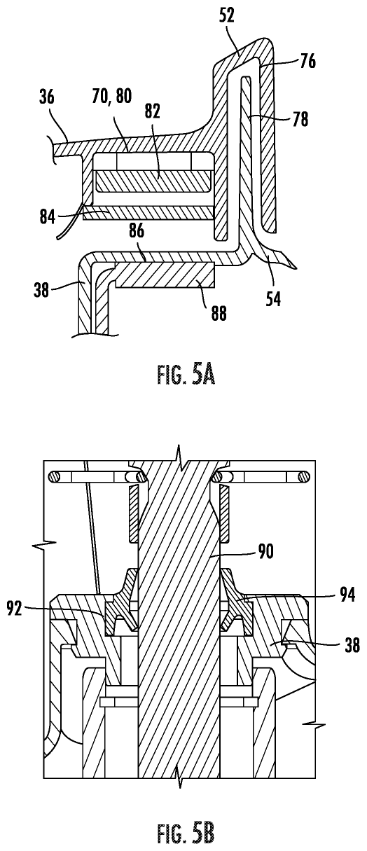

FIG. 5 is a cutaway isometric view of the maintenance module 26 with the maintenance tray 36 mounted over the effluent tray 38. A cavity 68 is defined between a lower surface 70 of the maintenance tray 36 and an upper surface 72 of the effluent tray 38. In the illustrated embodiment, the fluid outlet 64 extends into the cavity 68 directly above the downwardly extending conduit 56. The downwardly extending conduit 56 extends to a waste receptacle 74.

FIG. 5A is a cross-sectional view that illustrates some additional details from FIG. 5. The periphery 52 of the maintenance tray 36 and the periphery 54 of the effluent tray 38 interengage when the maintenance tray 36 is removably mounted over the effluent tray 38. The periphery 52 of the maintenance tray 36 defines a downwardly facing recess 76. The periphery 54 of the effluent tray 38 defines an upwardly extending peripheral ridge 78. Interengagement occurs when the upwardly extending ridge 78 is received into the downwardly facing recess 76. This interengagement is important for containing waste material within the cavity 68.

The lower surface 70 of the maintenance tray 36 also defines a downwardly facing recess 80. Within the recess 80 is a magnet 82. The recess 80 is closed off by a cover 84. Mounted on a lower surface 86 of the effluent tray 38 is a hall effect sensor 88. The hall effect sensor 88 generates a signal indicative of a magnetic field generated by the magnet 82 to allow installation of the maintenance tray 36 onto the effluent tray 38 to be verified.

FIG. 5B is a cross-sectional view that illustrates further details from FIG. 5. The maintenance tray 36 is coupled to a motorized shaft 90. The motorized shaft 90 is coupled to motor 40 (FIG. 3) which is in turn controlled by the controller 28. The motorized shaft 90 passes through an opening 92 in the effluent tray 38 and is coupled to the lower side 70 of the maintenance tray 36. A seal 94 mounted within the opening 92 provides a sliding seal between the shaft 90 and effluent tray 38 to prevent waste fluid from leaking out of the opening 92.

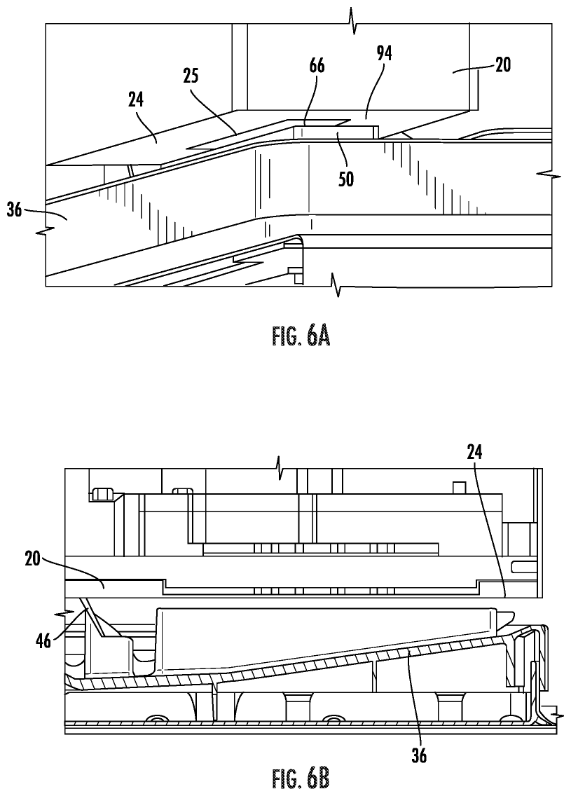

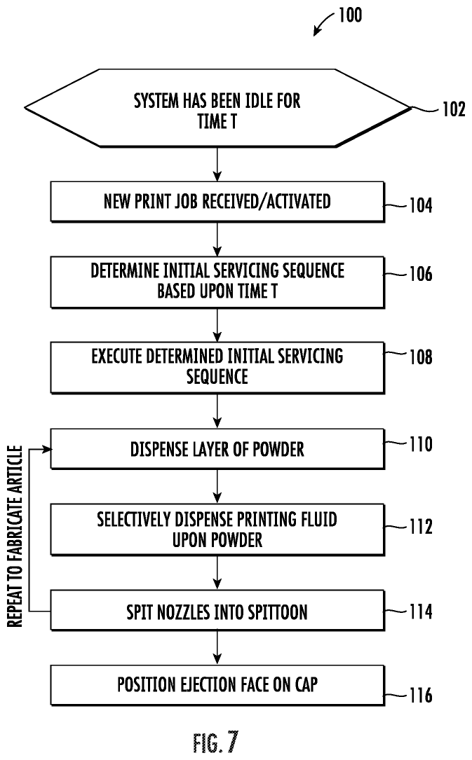

FIGS. 6A and 6B illustrate certain maintenance operations. The printhead 20 has a downward facing ejection face 24 with an array of nozzles 25. The nozzles are divided up into groups, with each group for ejecting a different printing fluid.

FIG. 6A is an isometric drawing depicting the printhead 20 positioned above the purge platform 50. The view of FIG. 6A is generally looking upward and sideways toward the printhead 20 so that the downward facing ejection face 24 is in view. The ejection face 24 of printhead 20 is in facing relation with the upper surface 66 of the purge platform 50. A space 94 is defined between the ejection face 24 and the upper surface 66. In some illustrative embodiments, a vertical distance between the ejection face 24 and the upper surface 66 can be in a range of one to three millimeters.

In a purge operation, the fluid supply 18 supplies pressurized printing fluid to the printhead 20 until the space 94 is at least partially filled with printing fluid. In some illustrative embodiments an amount of fluid that is purged into the space 94 is about 1 gram to 10 grams by weight. In other illustrative embodiments an amount of fluid that is purged into the space 94 is about 1 cubic centimeter to 10 cubic centimeters by volume. The printing fluid may vertically span the space 94 but not entirely span the space 94 laterally. During the purge operation, the movement mechanism 22 can laterally move the printhead in X and Y until the ejection face 24 is fully wetted. During such an operation, the nozzles 25 may absorb the printing fluid by capillary action. Because a plurality of different printing fluids are employed, the absorbed fluid may be a mixture of the different printing fluids.

FIG. 6B illustrates the printhead 20 being translated in the −X direction as the ejection face 24 passes over the wiper blade 26 to remove bulk ink after the purge (from FIG. 6A) is complete.

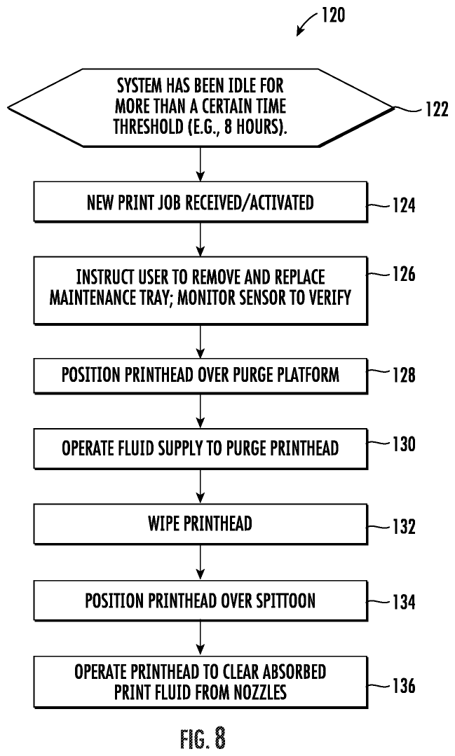

FIG. 7 is a flowchart depicting an embodiment of a method 100 for fabricating a three-dimensional article 4. According to 102, the system has been idle for a time period T with the ejection face “parked” against the storage cap 44. According to 104, a new print is received by system 2.

According to 106, an initial servicing sequence is determined based upon the time T. According to 108, the initial servicing sequence determined in step 106 is executed.

According to 110, the powder dispenser 16 is operated to dispense a layer of powder onto the build plate 6. According to 112, printing fluid is selectively dispensed upon the powder to bind the powder. According to 114, the printhead 20 is passed over the first spittoon 48 and nozzles are “spit” into the spittoon 48. In step 114, emphasis is particularly on nozzles that are not used during the printing. As indicated by the return arrow, steps 110-114 are repeated until the article 4 is fully fabricated. Finally, according to 116, the ejection face 24 is “parked” against the storage cap 44.

The method 100 can vary from the illustrated sequence. For example, orders of the steps can vary. In one implementation, step 110 may occur during or before step 108 for the first layer of powder. In another implementation the system 2 can form articles 4 from UV curable printing fluids that do not require a powder. Then step 110 would not be included.

FIG. 8 is a flowchart that illustrates a particular embodiment of a method of maintaining the printhead 20 if system 2 has been idle for a time period T that is greater than some threshold. FIG. 8 corresponds to part of FIG. 7 as a particular example. For example, element 122 of FIG. 8 corresponds to element 102 of FIG. 7. Element 124 of FIG. 8 corresponds to element 104 of FIG. 7. Elements 128 to 136 of FIG. 8 corresponds to element 108 of FIG. 7.

According to 122, the system has been idle for a time T that exceeds a threshold. For example, the threshold can be 8 hours.

According to 124, a new print job is received. According to 126, the operation is halted and the user is instructed to remove and replace the maintenance tray 36. When the user removes tray 36, an indication is received of the removal of tray 36. The indication can be an absence of a signal from the sensor 8. Later, when the user replaces the maintenance tray 36 (with either the same tray 36 after cleaning or another clean tray 36) a signal is received indicating a new presence of the maintenance tray 36. Then the process moves to step 128.

According to 128, the movement mechanism 22 and motor 40 are activated to position the printhead 20 over the purge platform 50. There is then a controlled space between the ejection face 24 and the upper surface 66 of the purge platform.

According to 130, the fluid supply 18 is activated to purge printing fluid through the printhead 20 and out of nozzles of the ejection face 24. In an illustrative embodiment, the purged fluid vertically spans the space 94 (FIG. 6A discussion). In an illustrative embodiment, the printing fluid includes a plurality of different printing fluids which mix in the space 94 between the ejection face 24 and the upper surface 66 and are then drawn into the nozzles 25. As part of step 110, the movement mechanism can laterally translate the printhead in X and Y and the ejection face 24 can be fully wetted by the purged printing fluid.

According to 132, the movement mechanism 22 is activated to pass the ejection face 24 over the wiper blade 46 to wipe the mixed printing fluid off of the ejection face 24. According to 134, the movement mechanism is activated to move the ejection face over the first spittoon 48 or the second spittoon 59. According to 136 the printhead 20 is activated to eject drops from the nozzles until they are purged of fluid that they received during step 110.

After step 136 is completed, the process can proceed to step 110 or 112 of FIG. 7 for the fabrication of the article 4 in a layer-by-layer manner. The method steps of FIGS. 7 and 8 are executed by the controller 28 acting upon components of system 2.

The disclosed system 2 can be used for a wide range of applications. One example of an application is the formation of a medical material or device requiring sterile surfaces and bulk materials. The maintenance module 26, with the maintenance tray 36 being removable and replaceable, minimizes or prevents a buildup of a bacterial growth on the maintenance tray 36. The effluent tray 38 captures excess fluid and prevents components of system 2 from being contaminated.

Another example of an application is for food printing. With food printing, the printing fluid can be a colored binder which can be difficult to dispense reliably. The use of the purge platform with a non-porous upper surface 66 allows the printhead to be fully purged. The colored binder requires a use of different primary colors that can be purged at once onto the upper surface 66. When this is done, the primary colors can mix upon the surface 66 and then be drawn into the nozzles by capillary action. The steps of wiping and then printing into a spittoon removes mixed colors from the nozzles.

Yet other examples of applications include the fabrication of non-food articles 4 using adhesive binding agents. The maintenance module 26 and the maintenance method maintain reliable operation and prevent sensitive printer components from being contaminated with the binding agents.

The specific embodiments and applications thereof described above are for illustrative purposes only and do not preclude modifications and variations encompassed by the scope of the following claims.

1. A three-dimensional printing system comprising:
a printhead including an ejection face with a plurality of nozzles for ejecting droplets of printing fluid;
a movement mechanism coupled to the printhead;
a maintenance module for maintaining the printhead, the maintenance module including:
a maintenance tray having a lateral periphery and an upper side including a storage cap defining a volume configured to receive and at least temporarily retain a volume of the droplets of the printing fluid, a wiper, and a spittoon separate from the storage cap, wherein:
the storage cap comprises an array of pillars extending from a base of the storage cap away from the upper side of the maintenance tray and configured to absorb the droplets of the printing fluid; and
the array of pillars include a plurality of spaced-apart pillars that allow the storage cap to operate as a second spittoon; and
an effluent tray having a lateral periphery and underlying the maintenance tray, wherein:
the effluent tray receives accumulated fluid from the maintenance tray; and
the lateral periphery of the maintenance tray and the lateral periphery of the effluent tray interengage when the maintenance tray is removably mounted over the effluent tray; and
a controller configured to:
operate the printhead and the maintenance module to prepare the printhead for printing;
operate the movement mechanism and the printhead to dispense layers of fluid; and
operate the movement mechanism and the maintenance module to engage the storage cap against the ejection face after printing.

2. The three-dimensional printing system of claim 1 wherein the lateral periphery of the maintenance tray comprises a downwardly facing peripheral recess, the lateral periphery of the effluent tray comprises an upwardly extending peripheral ridge that is received into the downwardly facing peripheral recess to provide interengagement when the maintenance tray is removably mounted to the effluent tray.

3. The three-dimensional printing system of claim 1 wherein the maintenance tray and the effluent tray are interengaged along a complete perimeter of a cavity defined between a lower side of the maintenance tray and an upper side of the effluent tray.

4. The three-dimensional printing system of claim 1 wherein the effluent tray comprises a downwardly extending conduit coupled to a waste receptacle.

5. The three-dimensional printing system of claim 1 wherein the maintenance tray comprises a downwardly extending fluid outlet that extends from the upper side of the maintenance tray to within a cavity defined between a lower side of the maintenance tray and an upper side of the effluent tray.

6. The three-dimensional printing system of claim 4 wherein the maintenance tray further comprises a downwardly extending fluid outlet that extends from the upper side of the maintenance tray to within a cavity defined between a lower side of the maintenance tray and an upper side of the effluent tray.

7. The three-dimensional printing system of claim 6 wherein the downwardly extending fluid outlet is laterally positioned over the downwardly extending conduit.

8. The three-dimensional printing system of claim 1 wherein the maintenance tray comprises:
a lower surface defining a recess;
a magnet contained within the recess; and
a hall sensor mounted to a lower surface of the effluent tray for sensing a presence of the magnet.

9. The three-dimensional printing system of claim 8 wherein the controller is configured to verify a presence of the maintenance tray mounted over the effluent tray based upon a signal from the hall sensor.

10. The three-dimensional printing system of claim 1 wherein:
the effluent tray has an opening passing from a lower surface to an upper surface; and the three-dimensional printing system further comprises:
a motorized vertical shaft passing through the opening and coupled to a lower side of the maintenance tray, the motorized vertical shaft configured to raise and lower the maintenance tray to vary a relative vertical position of the maintenance tray with respect to the printhead.

11. The three-dimensional printing system of claim 10 further comprising a seal mounted within the opening and in sliding and sealing engagement with the motorized vertical shaft.

12. The three-dimensional printing system of claim 10 wherein the motorized vertical shaft is coupled to a motor, the controller is configured to operate the motor to vertically position the maintenance tray with respect to the ejection face of the printhead.

13. The three-dimensional printing system of claim 1 wherein the movement mechanism is configured to laterally translate the printhead along two lateral axes, the maintenance module is configured to translate the maintenance tray along a vertical axis.

14. The three-dimensional printing system of claim 1 wherein the maintenance tray further comprises a purge platform having a non-porous upper surface for receiving the printing fluid during a printhead purge operation.

15. A method comprising:
providing a printhead including an ejection face with a plurality of nozzles for ejecting droplets of printing fluid;
providing a movement mechanism coupled to the printhead;
providing a maintenance module for maintaining the printhead, the maintenance module including:
a maintenance tray having a lateral periphery and an upper side including a storage cap defining a volume configured to receive and at least temporarily retain a volume of the droplets of the printing fluid, a wiper, and a spittoon separate from the storage cap, wherein:
the storage cap comprises an array of pillars extending from a base of the storage cap away from the upper side of the maintenance tray and configured to absorb the droplets of the printing fluid; and
the array of pillars includes a plurality of spaced-apart pillars that allow the storage cap to operate as a second spittoon; and
an effluent tray having a lateral periphery and underlying the maintenance tray, wherein:
the effluent tray receives accumulated fluid from the maintenance tray; and
the lateral periphery of the maintenance tray and the lateral periphery of the effluent tray interengage when the maintenance tray is removably mounted over the effluent tray; and
providing a controller configured to:
operate the printhead and the maintenance module to prepare the printhead for printing;
operate the movement mechanism and the printhead to dispense layers of fluid; and
operate the movement mechanism and the maintenance module to engage the storage cap against the ejection face after printing.

16. The method of claim 15 wherein the lateral periphery of the maintenance tray comprises a downwardly facing peripheral recess, the lateral periphery of the effluent tray comprises an upwardly extending peripheral ridge that is received into the downwardly facing peripheral recess to provide interengagement when the maintenance tray is removably mounted to the effluent tray.

17. The method of claim 15 wherein the maintenance tray and the effluent tray are interengaged along a complete perimeter of a cavity defined between a lower side of the maintenance tray and an upper side of the effluent tray.

18. The method of claim 15 wherein the effluent tray comprises a downwardly extending conduit coupled to a waste receptacle.

19. The method of claim 15 wherein the maintenance tray comprises a downwardly extending fluid outlet that extends from the upper side of the maintenance tray to within a cavity defined between a lower side of the maintenance tray and an upper side of the effluent tray.

20. The method of claim 15 wherein the maintenance tray comprises:
a lower surface defining a recess;
a magnet contained within the recess; and
a hall sensor mounted to lower surface of the effluent tray for sensing a presence of the magnet.
